(19) United States
(12) Patent Application Publication
(10) Pub. No.: US 2025/0005637 A1
(43) Pub. Date: Jan. 2, 2025

(54) RECONCILIATION OF DISPUTES IN VIRTUAL WORLD TRANSACTIONS

(71) Applicant: INTERNATIONAL BUSINESS MACHINES CORPORATION, Armonk, NY (US)

(72) Inventors: Dinesh C. Verma, New Castle, NY (US); Shahrokh DAIJAVAD, Morgan Hill, CA (US); Dan Gutfreund, Brighton, MA (US); David Joel Edelsohn, White Plains, NY (US)

(21) Appl. No.: 18/216,771

(22) Filed: Jun. 30, 2023

(51) Int. Cl. G06Q 30/0601

(52) U.S. Cl. CPC G06Q 30/0609; G06Q 30/0643; G06Q 20/407

(57) ABSTRACT

A method, system, and computer program product are configured to: receive a list of attributes of a virtual world rendering of an object, the list of attributes having been created by a first user; receive a digital rendering of a physical object provided to a second user based on the virtual world rendering of the object; determine attributes of the physical object from the digital rendering; make a determination that the physical object matches or does not match the virtual world rendering of the object based on comparing the list of attributes to the determined attributes of the physical object; and notify the first user and the second user of the determination that the physical object matches or does not match the virtual world rendering of the object.

### BACKGROUND

Aspects of the present invention relate generally to virtual worlds and, more particularly, to the reconciliation of disputes in virtual world transactions.

A virtual world (also called a virtual universe or VU) is a computer-generated three-dimensional space in which users can interact with a computer-generated objects and other users. Users may access such virtual worlds by utilizing virtual reality (VR) and augmented reality (AR) devices. An individual may be represented in a virtual world by an avatar, which is a digital object rendered in the virtual world and visible to other users in the virtual world.

A metaverse is an example of a network of virtual worlds that are focused on social and economic connections. The presence of an individual in a metaverse is mapped in the metaverse through his/her avatar which interacts with the entities of the metaverse from shopping, to travelling, to attending events. Entities, such as other individuals in the metaverse or owners of branded products, may present in the metaverse offers for sale for real world objects. An individual may view representations of the object in the metaverse, agree to purchase the object, and then receive delivery of the object in the real world.

### SUMMARY

In a first aspect of the invention, there is a computer-implemented method including: receiving, by a processor set, a list of attributes of a virtual world rendering of an object, the list of attributes having been created by a first user; receiving, by the processor set, a digital rendering of a physical object provided to a second user based on the virtual world rendering of the object; determining, by the processor set, attributes of the physical object from the digital rendering; making, by the processor set, a determination that the physical object matches or does not match the virtual world rendering of the object based on comparing the list of attributes to the determined attributes of the physical object; and notifying, by the processor set, the first user and the second user of the determination that the physical object matches or does not match the virtual world rendering of the object.

In another aspect of the invention, there is a computer program product including one or more computer readable storage media having program instructions collectively stored on the one or more computer readable storage media. The program instructions are executable to: receive a list of attributes of a virtual world rendering of an object, the list of attributes having been created by a first user; receive a digital rendering of a physical object provided to a second user based on the virtual world rendering of the object; determine attributes of the physical object from the digital rendering; make a determination that the physical object matches or does not match the virtual world rendering of the object based on comparing the list of attributes to the determined attributes of the physical object; and notify the first user and the second user of the determination that the physical object matches or does not match the virtual world rendering of the object.

In another aspect of the invention, there is a system including a processor set, one or more computer readable storage media, and program instructions collectively stored on the one or more computer readable storage media. The program instructions are executable to: receive a list of attributes of a virtual world rendering of an object, the list of attributes having been created by a first user; receive a digital rendering of a physical object provided to a second user based on the virtual world rendering of the object; determine attributes of the physical object from the digital rendering; make a determination that the physical object matches or does not match the virtual world rendering of the object based on comparing the list of attributes to the determined attributes of the physical object; and notify the first user and the second user of the determination that the physical object matches or does not match the virtual world rendering of the object.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows an exemplary use in accordance with aspects of the present invention.

FIG. 4 shows a flowchart of an exemplary method in accordance with aspects of the present invention.

### DETAILED DESCRIPTION

Aspects of the present invention relate generally to virtual worlds and, more particularly, to the reconciliation of disputes in virtual world transactions. As virtual world, virtual reality, and augmented reality are used increasingly in commerce and other transactions, there may be a significant increase in the disputes among the buyers and sellers of objects within a virtual world. Since a virtual world, for example a metaverse, provides a visual rendering of the physical object for sale, an unscrupulous seller may advertise the representation of the object improperly. As a result of such a representation, the buyer of the transaction may not like the object when they take possession of the object in the real world. In this case, a dispute may arise between the buyer and the seller, which needs to be resolved.

In a traditional online eCommerce, such disputes are provided to the platform provider, e.g., buyers may complain about the purchase to the eCommerce platform provider who acts as the arbitrator between the buyer and the seller. However, the provider of the platform in a virtual world does not provide such a brokerage function between the buyer and the seller for transactions that occur in the virtual world. Unlike an online eCommerce store, the virtual world provider acts more like a shopping mall owner who rents space to a shop operator but does not provide dispute resolution or handle complaints from the buyers of the shop at the mall. The lack of a trusted third party makes conventional online dispute resolution (ODR) solutions ineffective in the context of a virtual world.

Implementations of the invention address these problems by providing a method, system, and computer program product that provide reconciliation of disputes in virtual world transactions. Implementations of the invention provide a technical solution to the problem of ineffective dispute resolution in a virtual world transaction when the description of an object in the virtual world space (i.e., a virtual environment such as a metaverse) does not match its characteristics in the physical space (i.e., the real world). Implementations introduce mechanisms that certify the attributes that are shown in the virtual world and the conditions which must be satisfied by the physical object when it is rendered into the virtual world. In embodiments, the seller provides a certification of those attributes. In embodiments, the buyer, on receipt of the physical object, performs its own rendering of the object in the virtual world. If the characteristics of the rendered object are not satisfied in the buyer's view of the virtual world, the dispute is resolved in favor of the buyer, otherwise in favor of the seller.

In embodiments, both a buyer and a seller have mechanisms which can render an object in the virtual world. Embodiments resolve a dispute between a buyer and a seller when the buyer feels that the physical object received in the real world does not match the properties of the object as they were described in the virtual world at the time of purchase. Implementations address this problem by introducing the concept of a certification. In embodiments, the certification lists all the attributes of the object that are shown in the virtual world, and which should be satisfied by the buyer's rendering of the physical object (i.e., the physical object provided to the buyer as a result of the virtual world transaction). In embodiments, the steps of the certification and sales process are as follows: (1) a seller provides a list of all attributes of the object and what they look like in the virtual world; (2) a buyer examines the object in the virtual world and enumerates the list of attributes; (3) the buyer and seller agree upon the list of attributes and their characteristics which is signed and agreed upon digitally, either as a signed document, non-fungible token (NFT), etc.; (4) when the buyer receives the physical object, the buyer provides a rendering in the virtual world of the physical object, and the system validates attributes of the buyer's rendering against the list of attributes in the agreement; (5) if the buyer's rendering in the virtual world matches the attributes in the agreement, then the seller has met its obligations, otherwise the buyer can refuse the delivery of the object.

In embodiments, the agreement can be implemented by various methods. In one example, a third-party mediator accepts payments from the buyer and releases the funds to the seller only when the buyer rendering matches the agreement. In another example, a delivery company provides a rendering in the virtual world of the physical object, e.g., when picking it up from the seller and when delivering it to the buyer. The delivery company then provides an independent way of validating that the virtual world representation was done properly by both the buyer and the seller. In another example, the mediation process is done by the virtual world platform provider. In another example, the mediation process is part of the customer service provided by the seller.

In accordance with aspects of the invention, a method, system, and computer program product for resolving disputes between buyers and sellers in a virtual world are configured to: provide for a seller to certify a list of attributes of the virtual world rendering of an object for sale; provide for a buyer and seller to create an agreement on the list of attributes that are to match in the virtual world; and provide for the buyer to create a virtual world rendering of the received object and compare it to the agreement to complete the transaction. A mediator can be used to release payments. A delivery entity may be used to upload both the buyer and seller version of the virtual world representation.

In accordance with additional aspects of the invention, there is a method for resolving disputes between buyers and sellers in a virtual environment, the method comprising: receiving a list of attributes of a virtual environment rendering of a physical object; creating an agreement between a buyer and a seller based on the list of attributes, wherein the list of attributes match the virtual rendering of a physical object; receiving a virtual world rendering of a received object; and comparing the virtual world rendering of the received object. The method may further comprise: a fully automated mediator for a class of disputes, the use of a mediator to release payments, or the use of a delivery entity to upload both buyer and seller version of the virtual world representation, specific approaches for agreement signing (service from virtual world provider, block-chain based approach) and approaches to sign/certify the virtual world rendering. In embodiments, the received list of attributes of the virtual environment rendering of a physical object is certified by the seller. In embodiments, the agreement between a buyer and a seller is based on the list of attributes and is created by the buyer and seller. The method may further comprise: converting a physical object into a virtual reality representation; and generating assurances about the conversion process, where the assurances facilitate requisite validation. The method may further comprise dynamically comparing seller conversion to virtual representation and buyer conversion to virtual representation, wherein comparing the two provides the agreed terms and provides the validation and automatic arbitration.

Implementations of the invention are necessarily rooted in computer technology. Virtual worlds, including metaverses, are inherently computer-based. Rendering objects in a virtual world comprises computer-based functions that affect and control the appearance of the virtual world itself, and these functions are necessarily carried out by a computer-based system. Moreover, using computer vision to extract information from digital images is inherently computer-based.

It should be understood that, to the extent implementations of the invention collect, store, or employ personal information provided by, or obtained from, individuals (for example, sale agreement terms, rendering of objects, etc.) such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

In accordance with aspects of the invention, there is a computer-implemented method, comprising: receiving, by a processor set, a list of attributes of a virtual world rendering of an object, the list of attributes having been created by a first user; receiving, by the processor set, a digital rendering of a physical object provided to a second user based on the virtual world rendering of the object; determining, by the processor set, attributes of the physical object from the digital rendering; making, by the processor set, a determination that the physical object matches or does not match the virtual world rendering of the object based on comparing the list of attributes to the determined attributes of the physical object; and notifying, by the processor set, the first user and the second user of the determination that the physical object matches or does not match the virtual world rendering of the object. In this manner, implementations of the invention advantageously provide an automated reconciliation process to determine whether a physical object that was delivered to a buyer matches what was represented in a virtual environment such as a virtual world.

In embodiments, the method further comprises using the determination that the physical object matches or does not match the virtual world rendering of the object to reconcile a dispute in a virtual world transaction involving the virtual world rendering of the object. In this manner, implementations of the invention advantageously provide an automated reconciliation process for a virtual world transaction.

In embodiments, the determination that the physical object matches or does not match the virtual world rendering of the object comprises a determination that the physical object matches the virtual world rendering of the object, and the method further comprises causing payment associated with the virtual world transaction to be provided to the first user. In this manner, implementations of the invention advantageously provide an automated reconciliation process that protects the seller when the seller made an accurate representation of the object in the virtual environment.

In embodiments, the determination that the physical object matches or does not match the virtual world rendering of the object comprises a determination that the physical object does not match the virtual world rendering of the object, and the method further comprises causing payment associated with the virtual world transaction to be returned to the second user. In this manner, implementations of the invention advantageously provide an automated reconciliation process that protects the buyer when the seller made an inaccurate representation of the object in the virtual environment.

In embodiments, the virtual world rendering of the object is viewable by individuals in the virtual world including the second user. In this manner, implementations of the invention advantageously provide an automated reconciliation process for objects that are represented and sold in a virtual environment such as a virtual world.

In embodiments, the determining attributes of the physical object from the digital rendering is performed using computer vision. In this manner, implementations of the invention advantageously provide an automated reconciliation process that automatically determines attributes of the physical object.

In embodiments, the comparing the list of attributes to the determined attributes of the physical object comprises comparing respective values of the list of attributes to corresponding respective values of the determined attributes of the physical object. In this manner, implementations of the invention advantageously provide an automated reconciliation process that compares plural corresponding attributes of the representation and the delivered object.

In embodiments, the method further comprises: storing the list of attributes in a blockchain; and retrieving the list of attributes from the blockchain when performing the comparing. In this manner, implementations of the invention advantageously provide an automated reconciliation process that provides confidence to the users by eliminating the possibility of tampering with the data. In embodiments, the method further comprises creating a non-fungible token representing the list of attributes, and retrieving the list of attributes from a non-fungible token.

In accordance with aspects of the invention, there is a computer program product comprising one or more computer readable storage media having program instructions collectively stored on the one or more computer readable storage media. The program instructions are executable to: receive a list of attributes of a virtual world rendering of an object, the list of attributes having been created by a first user; receive a digital rendering of a physical object provided to a second user based on the virtual world rendering of the object; determine attributes of the physical object from the digital rendering; make a determination that the physical object matches or does not match the virtual world rendering of the object based on comparing the list of attributes to the determined attributes of the physical object; and notify the first user and the second user of the determination that the physical object matches or does not match the virtual world rendering of the object. In this manner, implementations of the invention advantageously provide an automated reconciliation process to determine whether a physical object that was delivered to a buyer matches what was represented in a virtual environment such as a virtual world.

In embodiments, the program instructions are executable to use the determination that the physical object matches or does not match the virtual world rendering of the object to reconcile a dispute in a virtual world transaction involving the virtual world rendering of the object. In this manner, implementations of the invention advantageously provide an automated reconciliation process for a virtual world transaction.

In embodiments, the virtual world rendering of the object is viewable by individuals in the virtual world including the second user. In this manner, implementations of the invention advantageously provide an automated reconciliation process for objects that are represented and sold in a virtual environment such as a virtual world.

In embodiments, the determining attributes of the physical object from the digital rendering is performed using computer vision. In this manner, implementations of the invention advantageously provide an automated reconciliation process that automatically determines attributes of the physical object.

In embodiments, the comparing the list of attributes to the determined attributes of the physical object comprises comparing respective values of the list of attributes to corresponding respective values of the determined attributes of the physical object. In this manner, implementations of the invention advantageously provide an automated reconciliation process that compares plural corresponding attributes of the representation and the delivered object.

In embodiments, the program instructions are executable to: store the list of attributes in a blockchain; and retrieve the list of attributes from the blockchain when performing the comparing. In this manner, implementations of the invention advantageously provide an automated reconciliation process that provides confidence to the users by eliminating the possibility of tampering with the data.

In accordance with aspects of the invention, there is a system comprising a processor set, one or more computer readable storage media, and program instructions collectively stored on the one or more computer readable storage media. The program instructions are executable to: receive a list of attributes of a virtual world rendering of an object, the list of attributes having been created by a first user; receive a digital rendering of a physical object provided to a second user based on the virtual world rendering of the object; determine attributes of the physical object from the digital rendering; make a determination that the physical object matches or does not match the virtual world rendering of the object based on comparing the list of attributes to the determined attributes of the physical object; and notify the first user and the second user of the determination that the physical object matches or does not match the virtual world rendering of the object. In this manner, implementations of the invention advantageously provide an automated reconciliation process to determine whether a physical object that was delivered to a buyer matches what was represented in a virtual environment such as a virtual world.

In embodiments, the program instructions are executable to use the determination that the physical object matches or does not match the virtual world rendering of the object to reconcile a dispute in a virtual world transaction involving the virtual world rendering of the object. In this manner, implementations of the invention advantageously provide an automated reconciliation process for a virtual world transaction.

In embodiments, the virtual world rendering of the object is viewable by individuals in the virtual world including the second user. In this manner, implementations of the invention advantageously provide an automated reconciliation process for objects that are represented and sold in a virtual environment such as a virtual world.

In embodiments, the determining attributes of the physical object from the digital rendering is performed using computer vision. In this manner, implementations of the invention advantageously provide an automated reconciliation process that automatically determines attributes of the physical object.

In embodiments, the comparing the list of attributes to the determined attributes of the physical object comprises comparing respective values of the list of attributes to corresponding respective values of the determined attributes of the physical object. In this manner, implementations of the invention advantageously provide an automated reconciliation process that compares plural corresponding attributes of the representation and the delivered object.

In embodiments, the program instructions are executable to: store the list of attributes in a blockchain; and retrieve the list of attributes from the blockchain when performing the comparing. In this manner, implementations of the invention advantageously provide an automated reconciliation process that provides confidence to the users by eliminating the possibility of tampering with the data.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as reconciliation code at block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

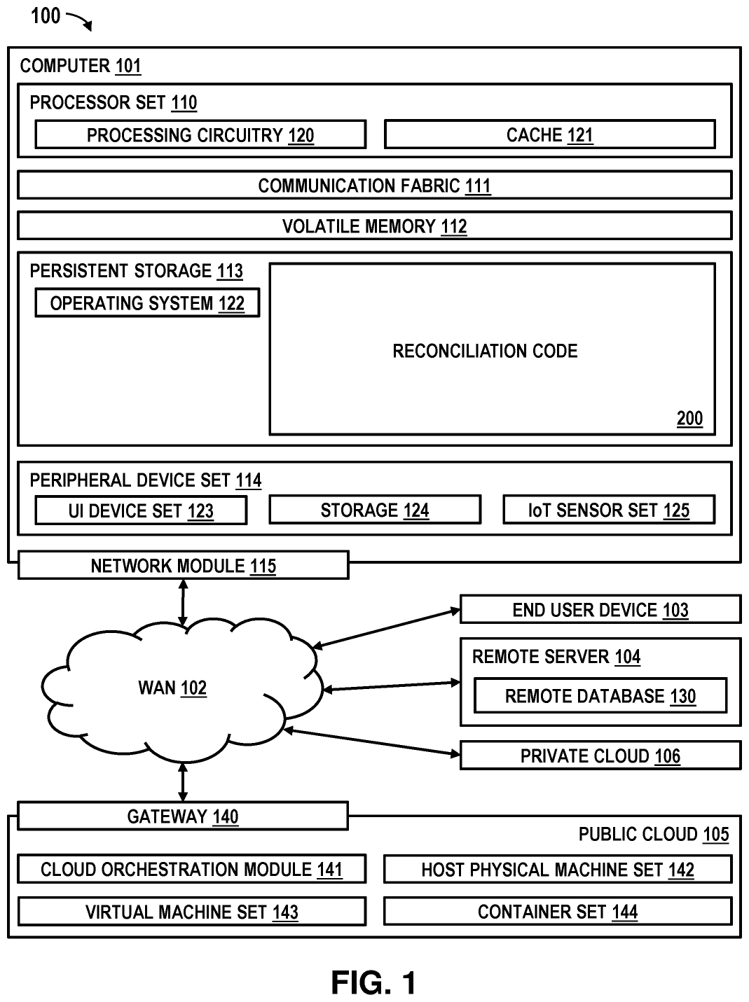

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

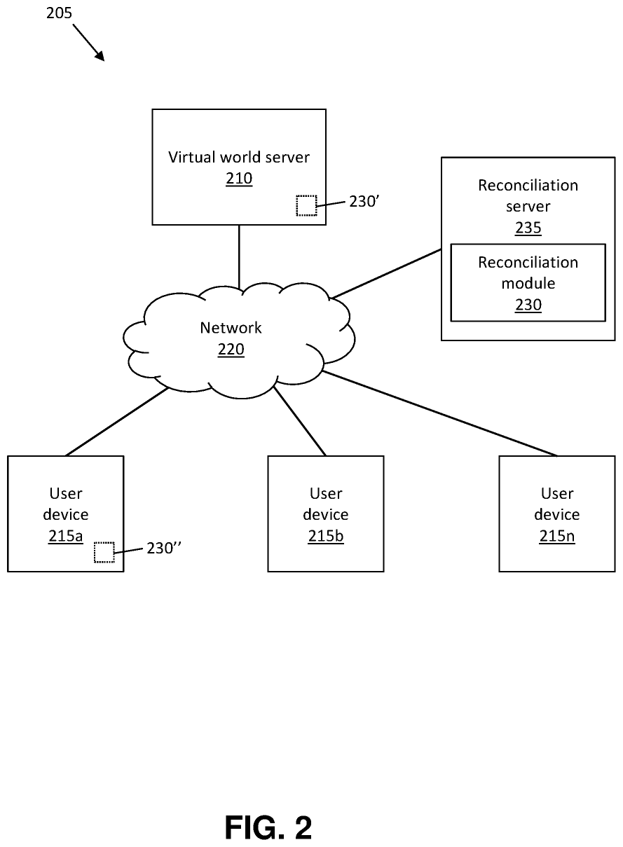

FIG. 2 shows a block diagram of an exemplary environment 205 in accordance with aspects of the invention. In embodiments, the environment 205 includes a virtual world server 210 that communicates with plural user devices 215a, 215b, . . . , 215n via a network 220. The virtual world server 210 may comprise one or more instances of the remote server 104 of FIG. 1, or one or more virtual machines or containers running on one or more instances of the remote server 104 of FIG. 1. In embodiments, the virtual world server 210 is part of a virtual world platform that provides (e.g., generates) a virtual world, such as a metaverse, that users may access via the user devices 215a-n. The user devices 215a-n comprise any number “n” of computing devices, such as EUD 103 of FIG. 1 that run a software client that interfaces with the virtual world platform to provide access to the virtual world. The user devices 215a-n may comprise virtual reality (VR) devices, augmented reality (AR) devices, desktop computers, laptop computers, tablets, smartphones, etc. The network 220 may comprise one more networks, such as a LAN, WAN, and the Internet. In one example, the network 220 comprises the WAN 102 of FIG. 1.

In accordance with aspects of the invention, the environment includes a reconciliation module 230, which may comprise one or more modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable (e.g., by processing circuitry such as the processing circuitry 120 of FIG. 1) to perform the inventive methods as described herein.

The reconciliation module 230 may be run on different devices in the environment in different implementations. In one example, the reconciliation module 230 is run on a reconciliation server 235, which may comprise one or more instances of the computer 101 of FIG. 1. In this example, the reconciliation server 235 is separate from the virtual world server 210 and the user devices 215a-n, such that the reconciliation server 235 represents a trusted third party for resolving disputes between buyers and sellers involved in transactions in the virtual world provided by the virtual world server 210. In another example, the reconciliation module 230′ is run on the virtual world server 210. In this example, the functions provided by the reconciliation module 230′ are provided by the virtual world platform as a service to the users of the virtual world. In another example, the reconciliation module 230″ is run on one of the user devices (e.g., 215a). In this example, the functions provided by the reconciliation module 230″ are provided by one of the users of the virtual world platform.

In accordance with aspects of the invention, the reconciliation module 230 is configured to perform a reconciliation method for a dispute arising between two users who participated in a transaction in the virtual world provided by the virtual world server 210. In a non-limiting example, the virtual world comprises a metaverse and the transaction is a transaction in the metaverse. The two users comprise a first user (e.g., a seller) associated with a first user device (e.g., 215a) and a second user (e.g., a buyer) associated with a second user device (e.g., 215b). Each of the first user and the second user may comprise an entity such as an individual or a company. In embodiments, the reconciliation method comprises: receiving list of attributes of a virtual world rendering of an object, the list of attributes having been created by a first user; receiving a digital rendering of a physical object provided to a second user based on the virtual world rendering of the object; determining attributes of the physical object from the digital rendering; making a determination that the physical object matches or does not match the virtual world rendering of the object based on comparing the list of attributes to the determined attributes of the physical object; and notifying the first user and the second user of the determination that the physical object matches or does not match the virtual world rendering of the object.

In accordance with aspects of the invention, the reconciliation module 230 is configured to perform the reconciliation method by acquiring information from each of the first user and the second user, validating the information, and arbitrating the dispute based on the validated information. In this manner, the reconciliation module 230 obtains information from each user, validates each user's information, and makes a determination in favor of one user based on the information. In embodiments, the reconciliation module 230 automates the reconciliation method by providing a protocol for the collection of information from each party, a mechanism for the validation of the information, and an arbitration logic (or policy).

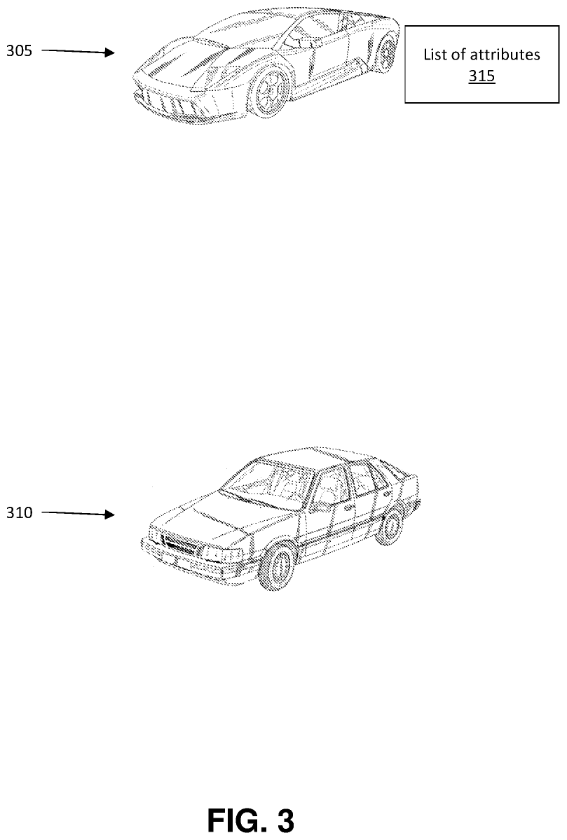

FIG. 3 shows an exemplary use in accordance with aspects of the invention. In FIG. 3, rendering 305 is a virtual world rendering of an object for sale by a first user (e.g., a seller using user device 215a to interact in the virtual world). The rendering 305 may comprise one or more digital images or other types of images displayed to users in a virtual world (e.g., virtual environment such as a virtual world). Users in the virtual world see the rendering 305 in the virtual world, e.g., at a storefront associated with the first user. In this example, a second user (e.g., a buyer using user device 215b to interact in the virtual world) sees the rendering 305 in the virtual world and decides to purchase the physical object represented by the rendering 305. In embodiments, as part of the transaction, the first user provides the second user with a list of attributes 315 that describe the virtual world rendering of the object. The attributes are defined by the first user and have names and values that describe the object. In this example, the attributes include: a first attribute named ‘object type’ with a value of ‘car’; a second attribute named ‘model’ with a value of ‘sports car’; a third value named ‘exterior color’ with a value of ‘ivory’; and a fourth value name ‘number of doors’ with a value of ‘two’. These examples are not limiting, and other types of attributes and/or other values of attributes and/or other numbers of attributes may be included in the list of attributes 315 for different transactions.

With continued reference to the example shown in FIG. 3, the second user accepts the list of attributes 315 when completing the transaction to purchase the physical object represented by the rendering 305. In embodiments, when the second user receives the physical object delivered as a result of the transaction, the second user can either accept the transaction or dispute the transaction based on the delivered physical object not matching the rendering 305. If the second user disputes the transaction, then the second user submits a rendering 310 of the delivered physical object as part of the dispute process. In embodiments, the rendering 310 comprises one or more digital images of the physical object that was delivered to the second user, i.e., the physical object that was delivered in the real world as a result of the virtual world transaction with the first user.

In embodiments, in response to the initiation of a dispute by the second user, the reconciliation module 230 determines values of attributes of the rendering 310 for each of the attribute types included in the list of attributes 315 that describe the rendering 305. In this particular example, the module 230 determines values of attributes of the rendering 310 for each of the attribute types of ‘object type’, ‘model’, ‘exterior color’, and ‘number of doors’. In embodiments, the module 230 compares the values of the attributes that describe the virtual world rendering of the object (e.g., determined from the agreed upon list of attributes 315) to the values of the attributes of the digital rendering of the delivered physical object (e.g., determined from the rendering 310). In embodiments, based on this comparison of values of attributes, the module 230 determines whether the first user or the second user wins the dispute. For example, if the module 230 determines that the values of attributes match, then the first user (i.e., the seller) wins the dispute because the virtual world rendering of the object is deemed to accurately represent the physical object that was delivered to the buyer. On the other hand, if the module 230 determines that the values of attributes do not match, then the second user (i.e., the buyer) wins the dispute because the virtual world rendering of the object is deemed to not accurately represent the physical object that was delivered to the buyer.

In accordance with aspects of the invention, the list of attributes 315 is provided to the second user prior to completion of the transaction in the virtual world. In one example, the list of attributes 315 is displayed to the second user as an object on the virtual world, such as a document with text that describes the names and values of the attributes. In another example, the list of attributes 315 is provided to the second user in a channel outside the virtual world, such as via email or text message. In either event, the second user is provided with the list of attributes 315 prior to the second user providing input that completes the transaction. In a particular example, when the second user provides input to purchase the object, the reconciliation module 230 causes the list of attributes 315 to be displayed to the second user in the virtual world. In this example, the second user provides input indicate that they accept with the list of attributes 315 (e.g., via a ‘I agree with the list of attributes’ button press or similar action) prior to the second user providing a final input to complete the transaction (e.g., via a ‘Complete the transaction’ button press or similar input).

In accordance with further aspects of the invention, prior to the second user accepting the list of attributes 315, the second user may suggest changes to the list of attributes 315. For example, the second user may be of the opinion that one or more values indicated in the list of attributes does not match the rendering 305. In this example, the second user and first user may communicate back and forth until they reach an agreed upon list of attributes 315. These communications may occur in a communication channel inside the virtual world or in a communication channel outside the virtual world. In embodiments, after reaching agreement on the list of attributes 315, the second user provides input to indicate that they accept with the list of attributes 315 (e.g., via a ‘I agree with the list of attributes’ button press or similar action) and then provides a final input to complete the transaction (e.g., via a ‘Complete the transaction’ button press or similar input).

In accordance with additional aspects of the invention, the list of attributes 315 may be stored in a computer-based distributed ledger such as a blockchain. For example, based on acceptance of the list of attributes 315 and completion of the transaction, the module 230 may add the list of attributes 315 as a block to a blockchain, where the added block contains a cryptographic hash of the previous block, a timestamp, and data defining the list of attributes 315. In embodiments, when the second user initiates a dispute, the module 230 retrieves the list of attributes 315 from the blockchain with the confidence that the list of attributes 315 contained in the blockchain cannot have been retroactively altered. This provides confidence to all parties involved in the transaction reconciliation process that the list of attributes 315 used during the reconciliation process is legitimate and not altered by either party.

In accordance with aspects of the invention, the reconciliation module 230 determines values of attributes of the rendering 310 using one or more computer vision techniques. Such techniques may include, for example and without limitation, multi-label object attribute classification using a convolutional neural network (CNN) that is trained to classify attributes of an object in a digital image. Another example and non-limiting technique includes using a hypotheses-CNN-pooling (HCP) network that is trained to produce a probability score for each attribute that an object in an image contains and take the top-ranked ones as the attributes of the object. In embodiments, the module 230 uses these or other computer vision techniques to determines a respective value of an attribute of the object in the rendering 310 for each respective attribute included in the list of attributes 315.

In accordance with aspects of the invention, the reconciliation module 230 determines whether the rendering 310 matches the list of attributes 315 by comparing the values of the attributes in list of attributes 315 to the values of the attributes determined from the rendering 310. In embodiments, the reconciliation module 230 compares the respective values of each attribute individually. For example, if the list of attributes contains four attributes including a first attribute, a second attribute, a third attribute, and a fourth attribute, then the module 230 compares the value of the first attribute from the list of attributes 315 to the value of this first attribute determined from the rendering 310. Similarly, in this example, the module 230 compares the value of the second attribute from the list of attributes 315 to the value of this second attribute determined from the rendering 310, and so on for the third and fourth attributes. In embodiments, the module 230 determines that the rendering 310 matches the list of attributes 315 if the values of all the respective attributes match, and the module 230 determines that the rendering 310 does not match the list of attributes 315 if one or more of the values of the respective attributes do not match.

In accordance with aspects of the invention, the reconciliation module 230 determines that two values match based on the two values being identical. For example, if the list of attributes 315 has a first attribute with a value of ‘car’ and the attributes determined from the rendering 310 have a first attribute with the value of ‘car’ then this is a match because the values of the compared attributes are identical. In another example, if the list of attributes 315 has a first attribute with a value of ‘car’ and the attributes determined from the rendering 310 have a first attribute with the value of ‘bicycle’ then this is a not match because the values of the compared attributes are not identical.

In accordance with aspects of the invention, the reconciliation module 230 may determine that two values match when they are not identical but are sufficiently similar. In embodiments, the module 230 may be programmed with sufficiently similar alternative values for different types of attribute value. For example, the module 230 may be programmed to accept the value ‘automobile’ as sufficiently similar to the value ‘car’. In this example, if the list of attributes 315 has a first attribute with a value of ‘car’ and the attributes determined from the rendering 310 have a first attribute with the value of ‘automobile’ then this is a match because the values of the compared attributes are sufficiently similar according to a defined metric.

In accordance with further aspects of the invention, the reconciliation process may include a third party that receives payment from the second user (e.g., the buyer) when the transaction is completed in the virtual world. In embodiments, if the second user initiates a dispute about the transaction and the module 230 decides the dispute in favor of the first user, then the module 230 sends a message to the third party to release the payment to the first user. In embodiments, if the second user initiates a dispute about the transaction and the module 230 decides the dispute in favor of the second user, then the module 230 sends a message to the third party to return the payment to the second user.

In this manner, the module 230 provides a process by which buyers and sellers in a virtual world transaction convert physical objects into virtual world representations, i.e., rendering 305 and rendering 310. The equipment to use for conversion, such as a digital camera, is present for all virtual world users. Assurances about the conversion process provide the requisite validation to satisfy both users. In embodiments, the seller conversion to a virtual representation (i.e., rendering 305) and the buyer conversion to virtual representation (i.e., rendering 310) are compared automatically by the module 230. In embodiments, this automated comparing of the two representations provides for validation and automatic arbitration of what was agreed upon and what was delivered.

In additional embodiments, the conversion to a virtual world representation (i.e., rendering 310) can be performed by a shipping company instead of the second user (e.g., buyer). In this embodiment, the shipping company takes delivery of the physical object from the first user (e.g., the seller), creates the rendering 310, and submits (e.g., uploads) the rendering 310 to the module 230.

In additional embodiments, an agreement between the first user and the second user (e.g., the seller and the buyer) can cover terms such as: methods/equipment to use for virtual world conversion; assurance about condition of item in the physical world; assurances about condition of item when converted into a virtual world representation; and processes to use when a dispute arises. In embodiments, the reconciliation process may utilize mediators that release funds to one user or the other based on the outcome of the dispute reconciliation. In embodiments, validation can be a platform function provided by the virtual world platform provider, provided by a reputable store, or provided by a third party.

In this manner, implementations of the invention provide a method, system, and computer program product for resolving disputes between buyers and sellers in a virtual world by: a seller certifying a list of attributes of the virtual world rendering of a physical object; a buyer and the seller creating an agreement on the list of attributes that are to match in the virtual world; the buyer creating a virtual world rendering of the received object and comparing it to the agreement to complete the transaction. The method, system, and computer program product may provide a fully automated mediator for a class of disputes, the use of a mediator to release payments, and/or the use of a delivery entity to upload both buyer and seller version of the virtual world representation. The method, system, and computer program product may additionally provide specific approaches for agreement signing (e.g., service from virtual world provider, block-chain based approach) and approaches to sign/certify the virtual world rendering.

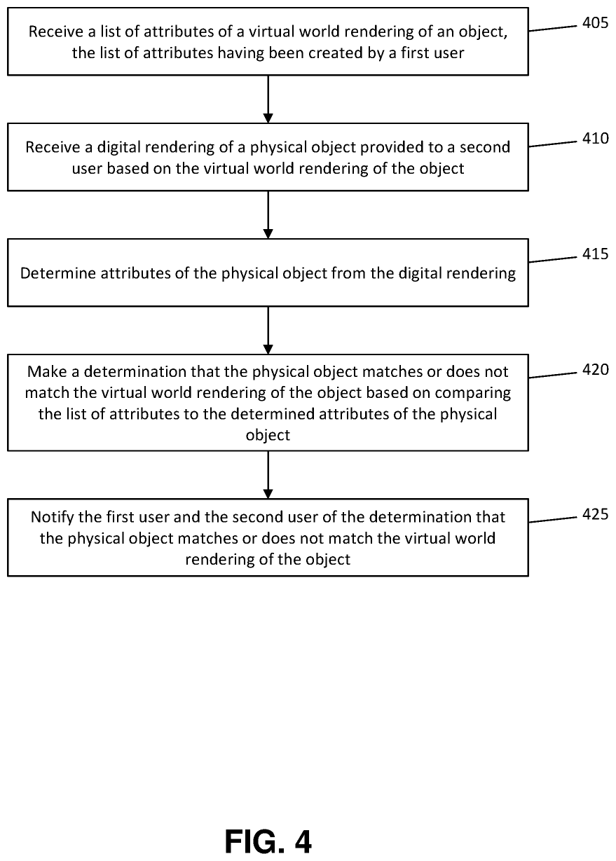

FIG. 4 shows a flowchart of an exemplary method in accordance with aspects of the present invention. Steps of the method may be carried out in the environment of FIG. 2 and are described with reference to elements depicted in FIG. 2.

At step 405, the system receives a list of attributes of a virtual world rendering of an object, the list of attributes having been created by a first user. In embodiments, the module 230 receives the list of attributes 315 from the first user (e.g., the seller) or from a blockchain. In embodiments, the virtual world rendering of an object comprises the rendering 305.

At step 410, the system receives a digital rendering of a physical object provided to a second user based on the virtual world rendering of the object. In embodiments, the module 230 receives a digital rendering 310 of the physical object received by the second user (e.g., the buyer) as a result of the virtual world transaction with the first user involving the virtual world rendering of the object (i.e., rendering 305).

At step 415, the system determines attributes of the physical object from the digital rendering. In embodiments, the module 230 uses computer vision with the rendering 310 to determine values of attributes of the physical object, these attributes corresponding to attributes included in the list of attributes 315.

At step 420, the system makes a determination that the physical object matches or does not match the virtual world rendering of the object based on comparing the list of attributes to the determined attributes of the physical object. In embodiments, the module 230 makes the determination based on comparing the values of the attributes in the list of attributes 315 to the values of the attributes of the physical object determined from rendering 310.

At step 425, the system notifies the first user and the second user of the determination that the physical object matches or does not match the virtual world rendering of the object. In embodiments, the module 230 notifies the first user and the second user by sending one or more messages to their user devices, e.g., 215a and 215b.

In embodiments of the method of FIG. 4, the determination that the physical object matches or does not match the virtual world rendering of the object is used to reconcile a dispute in a virtual world transaction involving the virtual world rendering of the object.

In embodiments of the method of FIG. 4, the virtual world rendering of the object (i.e., rendering 305) is viewable by individuals in the virtual world including the second user.

In embodiments of the method of FIG. 4, the determining attributes of the physical object from the digital rendering (i.e., rendering 310) is performed using computer vision.

In embodiments of the method of FIG. 4, the comparing the list of attributes to the determined attributes of the physical object comprises comparing respective values of the list of attributes to corresponding respective values of the determined attributes of the physical object.

In embodiments of the method of FIG. 4, the method further comprises: storing the list of attributes in a blockchain; and retrieving the list of attributes from the blockchain when performing the comparing.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a processor set, a list of attributes of a virtual world rendering of an object, the list of attributes having been created by a first user;
receiving, by the processor set, a digital rendering of a physical object provided to a second user based on the virtual world rendering of the object;
determining, by the processor set, attributes of the physical object from the digital rendering;
making, by the processor set, a determination that the physical object matches or does not match the virtual world rendering of the object based on comparing the list of attributes to the determined attributes of the physical object; and
notifying, by the processor set, the first user and the second user of the determination that the physical object matches or does not match the virtual world rendering of the object.

2. The computer-implemented method of claim 1, further comprising using the determination that the physical object matches or does not match the virtual world rendering of the object to reconcile a dispute in a virtual world transaction involving the virtual world rendering of the object.

3. The computer-implemented method of claim 2, wherein the determination that the physical object matches or does not match the virtual world rendering of the object comprises a determination that the physical object matches the virtual world rendering of the object, and further comprising causing payment associated with the virtual world transaction to be provided to the first user.

4. The computer-implemented method of claim 2, wherein the determination that the physical object matches or does not match the virtual world rendering of the object comprises a determination that the physical object does not match the virtual world rendering of the object, and further comprising causing payment associated with the virtual world transaction to be returned to the second user.

5. The computer-implemented method of claim 1, wherein the virtual world rendering of the object is viewable by individuals in the virtual world including the second user.

6. The computer-implemented method of claim 1, wherein the determining attributes of the physical object from the digital rendering is performed using computer vision.

7. The computer-implemented method of claim 1, wherein the comparing the list of attributes to the determined attributes of the physical object comprises comparing respective values of the list of attributes to corresponding respective values of the determined attributes of the physical object.

8. The computer-implemented method of claim 1, further comprising:
storing the list of attributes in a blockchain; and
retrieving the list of attributes from the blockchain when performing the comparing.

9. A computer program product comprising one or more computer readable storage media having program instructions collectively stored on the one or more computer readable storage media, the program instructions executable to:
receive a list of attributes of a virtual world rendering of an object, the list of attributes having been created by a first user;
receive a digital rendering of a physical object provided to a second user based on the virtual world rendering of the object;
determine attributes of the physical object from the digital rendering;
make a determination that the physical object matches or does not match the virtual world rendering of the object based on comparing the list of attributes to the determined attributes of the physical object; and
notify the first user and the second user of the determination that the physical object matches or does not match the virtual world rendering of the object.

10. The computer program product of claim 9, wherein the program instructions are executable to use the determination that the physical object matches or does not match the virtual world rendering of the object to reconcile a dispute in a virtual world transaction involving the virtual world rendering of the object.

11. The computer program product of claim 9, wherein the virtual world rendering of the object is viewable by individuals in the virtual world including the second user.

12. The computer program product of claim 9, wherein the determining attributes of the physical object from the digital rendering is performed using computer vision.

13. The computer program product of claim 9, wherein the comparing the list of attributes to the determined attributes of the physical object comprises comparing respective values of the list of attributes to corresponding respective values of the determined attributes of the physical object.

14. The computer program product of claim 9, wherein the program instructions are executable to:
store the list of attributes in a blockchain; and
retrieve the list of attributes from the blockchain when performing the comparing.

15. A system comprising:
a processor set, one or more computer readable storage media, and program instructions collectively stored on the one or more computer readable storage media, the program instructions executable to:
receive a list of attributes of a virtual world rendering of an object, the list of attributes having been created by a first user;
receive a digital rendering of a physical object provided to a second user based on the virtual world rendering of the object;
determine attributes of the physical object from the digital rendering;
make a determination that the physical object matches or does not match the virtual world rendering of the object based on comparing the list of attributes to the determined attributes of the physical object; and
notify the first user and the second user of the determination that the physical object matches or does not match the virtual world rendering of the object.

16. The system of claim 15, wherein the program instructions are executable to use the determination that the physical object matches or does not match the virtual world rendering of the object to reconcile a dispute in a virtual world transaction involving the virtual world rendering of the object.

17. The system of claim 15, wherein the virtual world rendering of the object is viewable by individuals in the virtual world including the second user.

18. The system of claim 15, wherein the determining attributes of the physical object from the digital rendering is performed using computer vision.

19. The system of claim 15, wherein the comparing the list of attributes to the determined attributes of the physical object comprises comparing respective values of the list of attributes to corresponding respective values of the determined attributes of the physical object.

20. The system of claim 15, wherein the program instructions are executable to:
store the list of attributes in a blockchain; and
retrieve the list of attributes from the blockchain when performing the comparing.
